(19) United States
(12) Patent Application Publication
(10) Pub. No.: US 2005/0040969 A1
(43) Pub. Date: Feb. 24, 2005

(54) Actuator unit and actuator control system for a motor vehicle

(76) Inventor: Detlef Heyn, Kirchhain (DE)

Correspondence Address: CARLSON, GASKEY & OLDS, P.C., 400 WEST MAPLE ROAD, SUITE 350, BIRMINGHAM, MI, 48009, US

(21) Appl. No.: 10/909,089

(22) Filed: Jul. 30, 2004

(30) Foreign Application Priority Data
Aug. 21, 2003 (DE) 103 38 459.6

(51) Int. Cl. G08C 19/00

(52) U.S. Cl. 340/825.72; 307/10.1; 340/5.72

(57) ABSTRACT

An actuator unit in a motor vehicle includes a wireless receiving device for receiving wirelessly transmitted data. A control unit comprises a wireless transmitting device that is tuned to the receiving device of the actuator unit, allowing the control unit to control operation of the actuator unit. The actuator unit and the control unit can be incorporated together to form an actuator control system with wireless capabilities.

### REFERENCE TO RELATED APPLICATIONS

The present invention claims the benefit of German Patent Application No. 103 38 459.6, filed Aug. 21, 2003.

### TECHNICAL FIELD

The invention relates to an actuator unit in a motor vehicle and to an actuator control system having an actuator unit and a control unit.

### BACKGROUND OF THE INVENTION

Motor vehicles often include a plurality of actuator units, such as sliding roof drives, window lifter drives and lifting magnet drives for closing systems. Actuator units need to integrate new functionalities, perform vehicle-specific coding, and set parameters to maintain optimal operation. In existing actuator units, these functions are possible only if there is a bus line system that provides a communication link with the actuator unit. In many cases, the bus line system is omitted due to the disproportionate cabling expenditure with respect to the benefits of communicating with the actuator unit. For end-of-line coding of actuator units during vehicle manufacture, however, communication with a control unit is required, which results in an increased expenditure in a vehicle production line.

There is a desire to provide a communication link with an actuator unit without requiring excessive cabling expenditures.

### SUMMARY OF THE INVENTION

The invention is generally directed to an actuator unit having a wireless receiving device for receiving wireless transmitted data. The invention is also directed to an actuator control system having an actuator unit with the receiving device and a control unit having a wireless transmitting device tuned to the receiving device.

The invention allows wireless communication with the actuator unit, allowing cabling and its associated expenditures to be eliminated. The inventive actuator unit and actuator control system allows integration of new functionalities into the actuator unit without being bound to wiring or cabling. Moreover, actuators can be coded via wireless communication. The wireless communication capabilities also allow parameterization and vehicle-specific coding of the actuator units so that, depending on defined general conditions (e.g., anti-pinch protection in sliding roofs and windows, heat protection, vehicle type, vehicle condition, etc.), the actuator units can achieve optimum performance.

Further features and advantages of the invention will be apparent from the following description of an embodiment and from the accompanying drawing to which reference is made.

### BRIEF DESCRIPTION OF THE DRAWINGS

FIG. 1 is a schematic illustration of an actuator control system comprising an actuator unit according to one embodiment of the invention.

### DETAILED DESCRIPTION OF THE PREFERRED EMBODIMENT

The invention is generally directed to an actuator unit having a receiving device for receiving data that is transmitted wirelessly rather than via a cable or wire. The invention is also directed to an actuator control system having an actuator unit with the wireless data receiving device and a control unit having a transmitting device tuned to the receiving device of the actuator unit.

The invention allows wireless communication with the actuator unit, allowing integration of new functionalities that are not bound to wiring or cabling into the actuator unit. Moreover, the actuator units can be coded via wireless communication. This is useful especially if vehicular communication paths are not provided to the actuator unit even though vehicle-specific coding is required in the actuator unit due to differing environmental conditions. The wireless communication also allows parameterization of the actuator units so that, depending on defined general conditions (e.g., anti-pinch protection in sliding roofs and windows, heat protection, vehicle type, condition of the vehicle, etc.), the actuator units can achieve optimum performance.

The receiving device of the actuator unit and the transmitting device of the control unit may be configured for radio transmission according to any desired wireless standard (e.g., 802.11b, Bluetooth, etc.). It is possible to use any suitable standard as a basis for development of the actuator units and control units without departing from the scope of the invention.

The actuator unit may include an energy storage device that is connected with a supply line of the vehicle or with a related supply line. The energy storage device allows wireless communication with the actuator unit without relying on any voltage from onboard circuitry of the vehicle or in a production line.

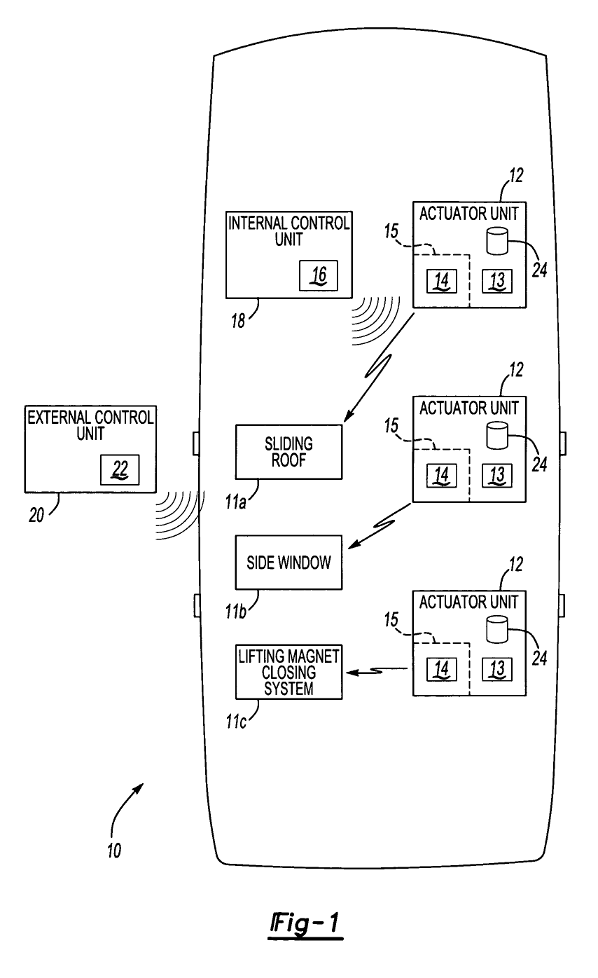

FIG. 1 illustrates a motor vehicle 10 comprising one or more functional components 11 and one or more actuator units 12. Although FIG. 1 illustrates a plurality of actuator units 12, the motor vehicle 10 may contain only a single actuator unit if desired. The actuator units 12 themselves may each include an actuator 13 for driving, for example, a sliding roof 11a, a side window 11b, a lifting magnet for a closing system 11c, or other components 11. In other words, a given actuator unit 12 may act as a sliding roof drive, side window drive, a lifting magnet drive, or other drive. A receiving device 14 is arranged on a circuit board 15 of the actuator unit 12. The receiving device 14 is tuned to a transmitting device 16 of an internal control unit 18 arranged within the vehicle 10. The transmitting device 16 and the receiving device 14 are designed for radio transmission and are subject to any applicable standard, such as the Bluetooth standard. Note that the receiving device 14 of each actuator unit 12 and the transmitting device 16 of the control unit 18 can be combined transmitting/receiving devices (i.e., transceivers) to allow bi-directional data transmission and receipt between the control unit 18 and the actuator units 12.

It is also possible to communicate with the actuator unit 12 from an external control unit 20 that is arranged outside the vehicle 10. The external control unit 20 also includes a transmitting device or a combined transmitting/receiving device 22. The external control unit 20 of this type may be provided in a vehicle service facility, for example. As a result, the coding and parameter setting of the actuator unit 12, and in particular integration of new functionalities, can be performed easily from outside the vehicle 10.

The actuator unit 12 further comprises a rechargeable energy storage device 24. The energy storage device 24 can be, for example, an accumulator or special capacitors (e.g., gold caps) that can be recharged through a connection to a supply line (not shown) of the vehicle 10. The energy storage device 24 acts as a buffered power supply that allows integration of new functions, coding and parameter setting regardless of whether a supply voltage is present in the supply line. Of course, the actions can be performed until the energy storage device 24 is discharged.

The above invention has been disclosed somewhat schematically. A worker in this art would recognize appropriate components and controls to achieve the goals and functions as discussed above.

It should be understood that various alternatives to the embodiments of the invention described herein may be employed in practicing the invention. It is intended that the following claims define the scope of the invention and that the method and apparatus within the scope of these claims and their equivalents be covered thereby.

1. An actuator unit for a component in a vehicle, comprising:
an actuator that controls operation of the component; and
a wireless receiving device that receives wireless data for communicating with the actuator unit.

2. The actuator unit according to claim 1, further comprising a circuit board, wherein the wireless receiving device is arranged on the circuit board.

3. The actuator unit according to claim 1, wherein the wireless receiving device is a combined wireless transmitting/receiving device.

4. The actuator unit according to claim 1, further comprising an energy storage device adapted to connect with a supply line of the vehicle.

5. The actuator unit according to claim 4, wherein the energy storage device comprises at least one accumulator.

6. The actuator unit according to claim 4, wherein the energy storage device comprises at least one capacitor.

7. The actuator unit according to claim 1, wherein the actuator unit is at least one selected from the group consisting of a sliding roof drive, a window lifter drive and a lifting magnet drive.

8. An actuator control system for a vehicle, comprising:
an actuator unit having
an actuator that controls operation of a component in the vehicle, and
a wireless receiving device that receives wireless data for communicating with the actuator unit; and
a control unit having a wireless transmitting device that is tuned to the wireless receiving device in the actuator unit.

9. The actuator control system according to claim 8, wherein at least one of the wireless receiving device in the actuator unit and the wireless transmitting device in the control unit is a combined wireless transmitting/receiving device.

10. The actuator control system according to claim 8, wherein the actuator unit further comprises an energy storage device adapted to connect with a supply line of the vehicle.

11. The actuator control system according to claim 8, wherein the actuator unit is at least one selected from the group consisting of a sliding roof drive, a window lifter drive and a lifting magnet drive.

12. The actuator control system according to claim 8, wherein the wireless receiving device of the actuator unit and the wireless transmitting device of the control unit are configured for radio transmission.

13. The actuator control system according to claim 12, wherein the receiving device and the transmitting device are configured according to a Bluetooth standard.

14. The actuator control system according to claim 8, wherein the control unit is an internal control unit arranged inside the vehicle.

15. The actuator control system according to claim 8, wherein the control unit is an external control unit arranged outside the vehicle.

16. The actuator control system according to claim 8, wherein said actuator unit comprises a plurality of actuator units and wherein said control unit is a single control unit communicating with said plurality of actuator units.
